(19) United States
(12) Patent Application Publication
(10) Pub. No.: US 2020/0295324 A1
(43) Pub. Date: Sep. 17, 2020

(54) MODULAR SMART BATTERY AND BATTERY MODULE FOR FAST SECURE FIELD ASSEMBLY

(71) Applicant: Pika Energy, Inc., Westbrook, ME (US)

(72) Inventor: Benjamin Francis Polito, Gorham, ME (US)

(21) Appl. No.: 16/818,692

(22) Filed: Mar. 13, 2020

Related U.S. Application Data
(60) Provisional application No. 62/818,593, filed on Mar. 14, 2019.

(51) Int. Cl. H01M 2/10

(52) U.S. Cl. CPC H01M 2/1077; H01M 2220/10

(57) ABSTRACT

A battery module includes a battery and an outer case surrounding the battery. The outer case has two ends, each end including a case feature for mating with retention features in a multiple battery module enclosure. Each end also includes an electrical terminal electrically coupled to the respective case feature. At least one end including a ramp feature for engaging at least one of the retention features in response to inserting the case into the multiple battery module enclosure.

### RELATED APPLICATION

This application claims priority to U.S. Provisional Application Ser. No. 62/818,593 (entitled MODULAR SMART BATTERY AND BATTERY MODULE FOR FAST SECURE FIELD ASSEMBLY, filed Mar. 14, 2019) which is incorporated herein by reference.

### BACKGROUND

The importance of distributed energy storage is increasing rapidly, due to the growth of solar and other distributed energy technologies, which have become a significant source of energy on electric grids worldwide. However, electricity storage products are often heavy, cumbersome, and expensive to install, increasing the cost and slowing the growth of this important energy technology. Further, the complexity of assembly and setup impacts the scalability of energy storage solutions.

### SUMMARY

A modular energy storage product comprises an enclosure and one or more battery modules, each of which is equipped with features that facilitate a fast, tool-free, secure installation.

In one embodiment, the battery module features ramps and slots, and the enclosure features flexural catches that engage the slots to secure the module without additional tools or parts. In other embodiments, while no tool is required to assemble the module, a tool may be required to remove the module. In further embodiments, the same motion that assembles the module to the enclosure also completes the electrical connection.

### BRIEF DESCRIPTION OF THE DRAWINGS

FIG. 1A is a cross-section view of a battery enclosure according to an example embodiment.

FIG. 1B is a perspective view of the battery enclosure of FIG. 2A showing internal battery modules and a battery management unit in broken line form according to an example embodiment.

FIGS. 2A, 2B, and 2C are block diagrams illustrating battery modules in various stages of insertion into a battery enclosure according to an example embodiment.

FIG. 2D is a perspective representation of a guide for latching battery modules in place according to an example embodiment.

FIG. 3A is a side elevation view of an alternative battery module according to example embodiments.

FIG. 3B is an illustration of insertion of the battery module of FIG. 2A into the battery enclosure according to an example embodiment.

FIG. 4 is a block schematic diagram illustrating electrical connections inside a battery enclosure according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

The importance of distributed energy storage is increasing rapidly, due to the growth of solar and other distributed energy technologies, which have become a significant source of energy on electric grids worldwide. However, electricity storage products are often heavy, cumbersome, and expensive to install, increasing the cost and slowing the growth of this important energy technology. Further, the complexity of assembly and setup impacts the scalability of energy storage solutions.

The industry would benefit from modular energy storage solutions that could be installed very quickly from simple, lightweight, components by assemblers with minimal training.

One prior energy storage system has a 13 kWh of capacity and weighs approximately 125 kg. Another prior energy storage system has a 9 kWh of capacity and weighs approximately 100 kg. A further commercial/industrial-type energy storage product has a housing and several rack-type horizontally oriented battery modules which must be secured with multiple small fasteners and connected using several external cables.

In various embodiments of the present inventive subject matter, a modular energy storage product comprises an enclosure and one or more battery modules, each of which is equipped with enclosure features that facilitate a fast, tool-free, secure installation. Electrical connections between battery modules may be internal to the energy storage product, obviating the need for separate cables between batteries.

In one embodiment, the battery module features ramps and slots, and the battery module features include flexural catches that engage the slots to secure the module without additional tools or parts. In other embodiments, while no tool is required to assemble the module, a tool may be required to remove the module. In further embodiments, the same motion that assembles the module to the enclosure also completes the electrical connection.

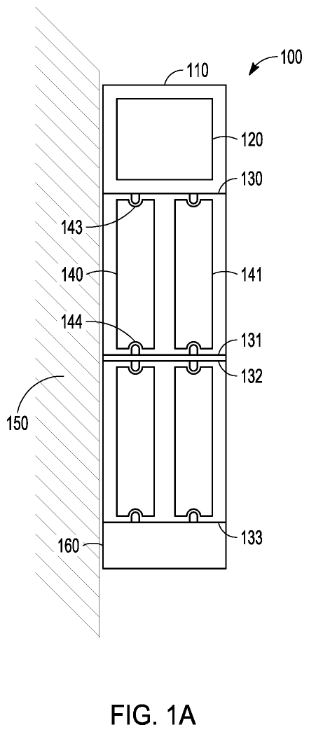

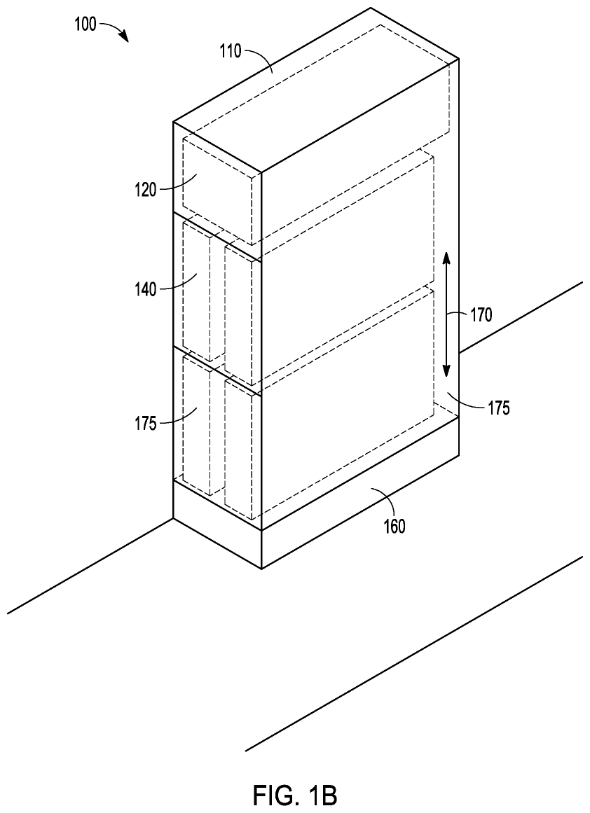

FIG. 1A illustrates a cross-section of an energy storage system 100 that includes a smart battery enclosure 110. Enclosure 110 may include a battery management unit 120, one or more guides 130, 131, 132, 133 with catch features, and one or more smart battery modules 140, 141 etc. The guides 130 may have sufficient structural support to fully support one or more battery modules within the enclosure 110 and be securely mounted within the enclosure such as by welding, or other means of securing the guides 130 within the enclosure 110.

The smart battery modules 140, 141 may include one or more battery cells enclosed within a case. The case may incorporate case features 143, 144 as illustrated on smart battery module 140. The mating features 143, 144 are configured to bypass and then securely engage the guide/catch features 130, 131 on the enclosure 110. The enclosure 110 may be self-supported or may attach to or be positioned adjacent a wall 150. The enclosure 110 may also be supported by a floor, and a foot, frame, or riser 160 may be used to elevate the enclosure 110 a desired distance from the floor.

FIG. 1B is a perspective transparent isometric view of the enclosure 110. While the stack configuration illustrated comprises two battery modules deep by two modules high, other configurations are readily devised, including single module depth, multiple modules side-by-side, etc. In some applications a plenum 170 provides a space to allow easy access to touch-safe electrical connectors on the side of the module to enable electrical coupling of the battery modules in various desired serial and parallel combination to obtain desired electrical properties of the system 110.

A removable panel 175 on a front side of enclosure 110 provides access to the inside of the enclosure 110, allowing insertion of the battery modules to engage with the matting features 143, 144 and hold the battery modules in place within the enclosure 110.

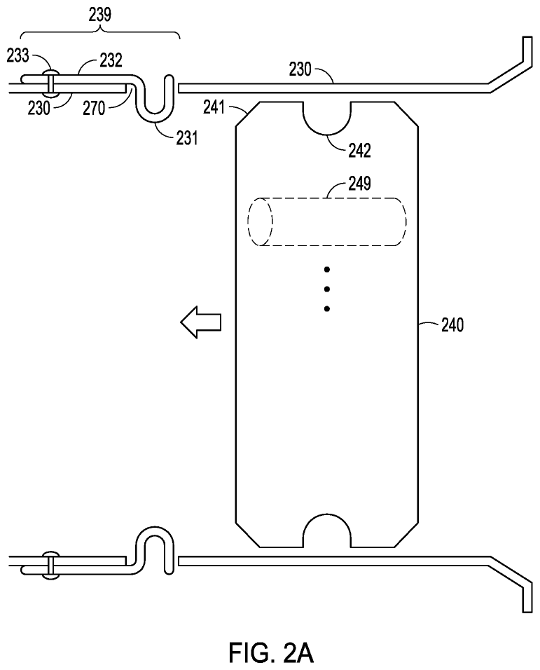

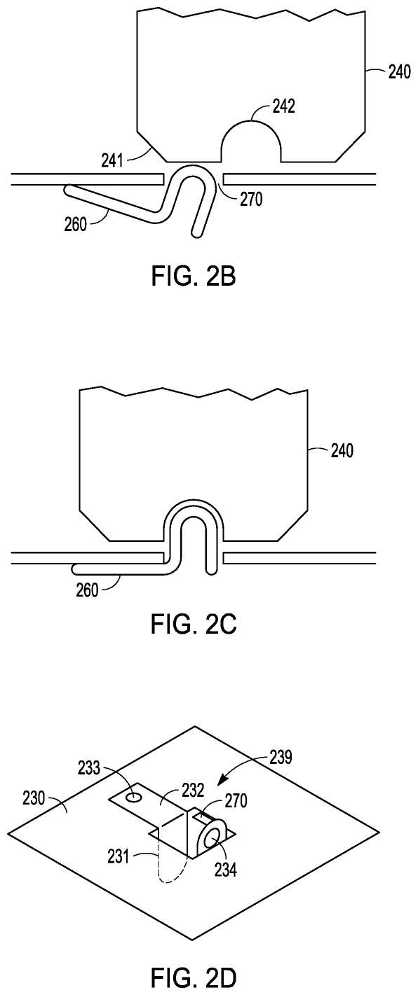

FIGS. 2A, 2B, and 2C are a series of a block diagram illustrating a process or method of secure battery module assembly and capture. In one embodiment, the installation may be performed without the use of tools. The system 100 provides a fast, secure module capture means is used to secure battery modules. Reference numbers for like parts in the various figures are used consistently.

At assembly, an installer may approach the enclosure 110 with panel 175 removed with one module 240 at a time. One or more guides 230 equipped with catches 239 are exposed with the panel 175 removed and enable the installer to laterally move the battery module 240 into the enclosure (not shown). The guides 230 may be supported within the enclosure as previously illustrated. The battery module 240 may include multiple cells 249, indicated in broken line form.

Ramp features 241 enable the module 240 to displace the catches 239 outward away from the battery module 240. In one orientation, the battery modules are vertically oriented, and the catches 239 are vertically displaced through an opening 270 of guide 230 as illustrated at 260 in FIG. 2B, allowing the module to slide further back into the enclosure, whereupon the catches 239 on guides 230 located to engage both ends of the battery module 240 securely engage female receiving features 242 on the battery modules 240, securing the module in place as illustrated in FIG. 2C.

A FIG. 2D is a perspective representation of the guide 230 for latching battery modules in place. In one embodiment, catch 239 is a flexural catch formed from a rectangular piece of sheet metal. The catch 239 is formed roughly into an elongated P shape, comprising a male catch feature 231, a flexure 232, and an attachment 233, such as a weld, adhesive, or other means of securing the flexure 232 to the guide 230 to allow flexing of the male catch feature 231. In FIG. 2D, the catch feature 231 is shown as extending downward, with a near end extending above the surface of guide 230, and having a hole or slot 234 that can receive a tool such as a screwdriver to lift the male catch feature out of engagement with the receiving feature for removing the battery module. The flexure 232 and male catch feature 231 may be formed of a single piece of flexible material, such as plastic or metal in various embodiments. Other materials that have a spring constant sufficient to provide suitable flexibility and retentive strength may be used in further embodiments.

The male catch feature 231 has an arcuate portion extending convexly towards the intended position of an installed battery through an opening 270 in the guide 230. The male catch feature may have a shape that mates with the corresponding concave female receiving feature 242 of the battery module, or otherwise suitably engages with the male catch feature to provide spring force to retain the battery module in a desired position. There are two opposed guides 230 spanning a distance commensurate with a battery module. There are also two opposed catches 239 for each battery module to be installed. In one embodiment, there are two battery modules for each pair of guides 203, resulting four catches 239. Each level in the enclosure 110 may be similarly configured and may accommodate different size batteries and different numbers of batteries with corresponding number of pairs of catches.

In operation, as the module is pushed toward the back of the enclosure, the battery module diagonal ramps 241 contact the catch features 231, displacing the catch features away from the module against the elastic restoring force of the flexures 232, until the module slides to the point where the catches 231 can relax into the receiving features 242, urged by the flexures 232. This construction is relatively simple and compatible with sheet metal fabrication techniques. In other embodiments, spring-loaded catches, stamped or formed catches, magnetic catches, or other securing means may be employed. In still other embodiments, the catch may be integrated with the module, and the receiver integrated with the housing. Different shape catches and catch features may be used with different shaped receiving features 242 to provide similar ease of installation. While the diagonal ramps 241 are shown as similar to large chamfers, other shaped ramps, such as arcuate or otherwise may be used to provide a similar catch displacement function. The ramps should have angles that result in a reasonable amount of force being able to displace the catches so the catches can engage with the receiving features 242.

FIG. 2B shows bottom catch 260 being displaced by ramp feature 241, just before the catch 231 snaps into receiving feature 242 of the battery module 240.

FIG. 2C shows bottom catch 231 retentatively engaged in receiving feature 242 of the bottom of battery module 241, securing it in place upon insertion. Note that top catches 231 may be similarly displaced and then engaged at the same time or sequentially to complete installation of each battery module, followed making appropriate electrical connections and closing of the panel 175.

In some embodiments, the catch feature 231 may be designed such that no tool is required to secure the module to the smart battery enclosure. The catch feature 231 may also be designed so that a tools may be required to remove a battery module. FIG. 2D illustrates the catch feature 231 with the slot 234 that is substantially parallel to the guide 230 that effectively allows a screwdriver or other thin tool to engage and lever the catch 231 out of position. The slot 234 may be positioned proximate or above the guide 230 such that it is accessible for such levering of the catch 231. The slot 234 may comprise a round hole or even a protrusion or other structure sufficient to allow a tool to lever the catch out of position in further embodiments.

While the catch/receiver features are shown on the top and bottom of the module, other configurations may be advantageous depending on the overall product architecture. For instance, the battery modules are shown as having an elongated box or book-like shape. In further embodiments, a cube or other structure may prove more efficient or otherwise desirable. Guides with catches may be positioned vertically to contact mating receiving features on opposing sides of the battery modules.

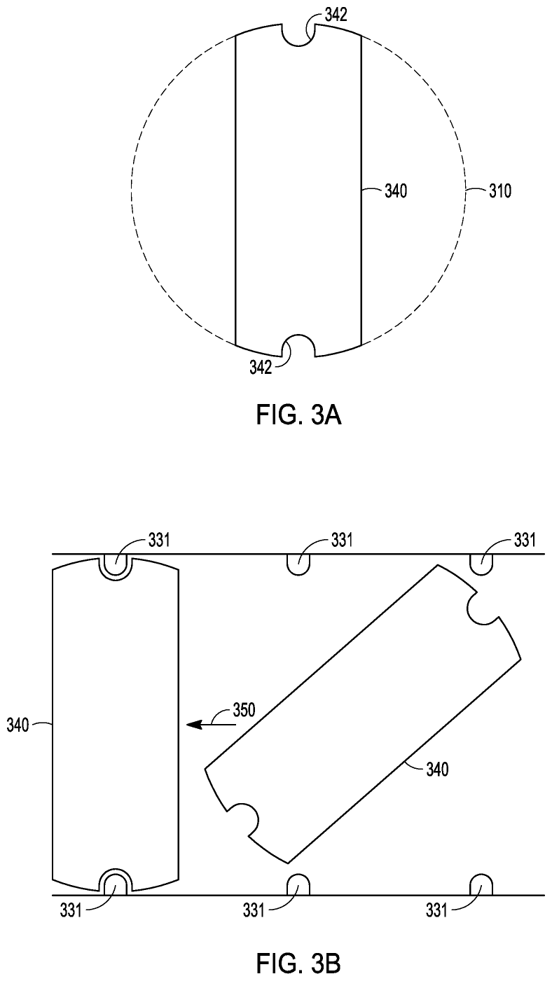

FIG. 3A is a side elevation view of an alternative battery module 340. In some embodiments such as that of FIG. 1A with multiple modules stacked in the direction normal to the wall surface, it may be advantageous for the modules to be formed to facilitate streamlined tool-free assembly. Module 340 has top and bottom arcuate surfaces substantially taking the form of a cylinder illustrated by broken line 310, having arcuate top and bottom ends, with receivers 442 as previously described. The cylinder has a diameter the same as or slightly less than the distance between opposing guides of the enclosure in one embodiment. The arcuate surfaces may provide a ramp feature to displace catches 331 in some embodiments.

FIG. 3B is an illustration of insertion of the battery module 340 in a partially diagonal orientation, readily bypassing several catches 331 before engaging the rearmost opposing set of catches as described above, with movement illustrated by arrow 350.

In some embodiments, the battery module 340 may have the convex shaped receivers with the enclosure including the concave catches. In still further embodiments, the battery module 340 may have a different feature on each end, such as a concave feature for a positive or negative terminal and a convex feature for the opposite polarity terminal, or vice versa. The enclosure and/or guides 230 may have suitable mating features to provide a keyed engagement mechanism. The features may be referred to as male and female features.

In some embodiments, electrical connectors may be integrated into the catches, such that engaging the module also forms the necessary electrical connections to the module, with the receiving features 342 of each battery module 340 including electrical connections to positive and negative terminals of the battery cells within each battery module 340.

In some embodiments, modules may be staggered, offset, or otherwise configured without departing from the design intent, for instance to permit backplane connectors on the modules to engage with mating connectors on the enclosure.

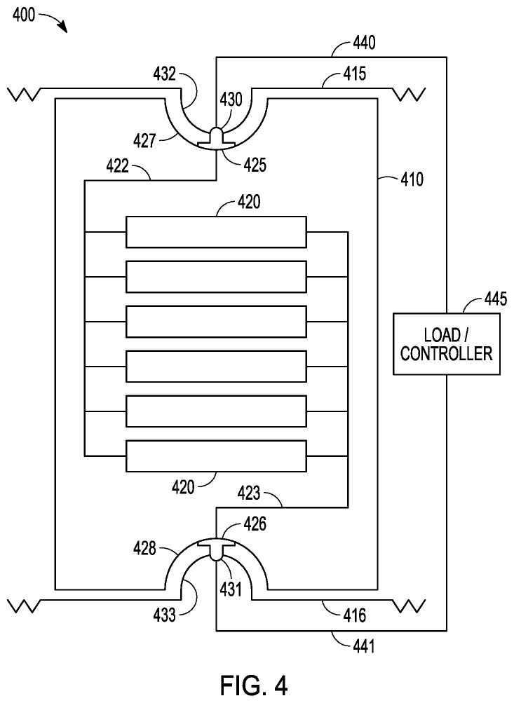

FIG. 4 is a block schematic diagram illustrating electrical connections inside a battery enclosure generally at 400. A battery module 410 is shown captured by opposing guides 415 and 416. While one module 410 is shown for simplicity of illustration, there may be multiple installed battery modules in further embodiments. The battery module 410 is shown comprising multiple battery cells 420 that are connected in parallel via positive and negative conductors 422 and 423 respectively. The conductors are coupled to the respective guides 415 and 416 at electrical contact points 425 and 426 respectively. The electrical contact points 425 and 426 provide an electrical contact through respective receiving features 427 and 428. The contact points 425 and 426 may comprising a conductive plate in one embodiment, or any other type of contact suitable for connecting to opposing contacts.

The contact points 425 and 426 provide a means to contact respective contacts 430 and 431 on catch features 432 and 433. The contacts 430 and 431 are electrically coupled to connectors 440 and 441 which may be coupled to a load 445 or coupled to other battery modules in series or in parallel, or a combination of serial and parallel connection to provide an energy storage system with desired voltage and current characteristics.

The contacts 430 and 431 on the catch features 432 and 433 may be biased against the contacts 425 and 426 due to spring force exerted by the catch features. The contacts 430 and 431 may comprise a bulged construction suitable for conductively contacting the corresponding contacts 425 and 426.

In further embodiments, the battery cells 420 or battery module 410 may have external connections to allow wiring via such connections to provide desired electrical characteristics.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A battery module comprising:
a battery cell;
an outer case surrounding the battery cell, wherein the outer case has two ends:
each end of the outer case including a case feature for mating with retention features in a multiple battery module enclosure; and
at least one end including a ramp feature for displacing at least one of the retention features of the battery module enclosure in response to inserting the case into the multiple battery module enclosure.

2. The battery module of claim 1 wherein each end includes an electrical terminal electrically coupled to the respective case feature.

3. The battery module of claim 1 wherein the ramp feature is convex.

4. The battery module of claim 1 wherein the ramp feature is a straight chamfer.

5. The battery module of claim 1 wherein the case feature on a first end of the battery module is convex and the case feature of a second end of the battery module is concave.

6. The battery module of claim 1 wherein the case feature on a first end of the battery module is convex and the case feature of a second end of the battery module is also convex.

7. The battery module of claim 1 wherein each end of the case has a ramp to contact and move respective retention features in response to inserting the case into the multiple battery module enclosure a distance corresponding to the case features, upon which the retention features mate with the case feature to retain the case in the multiple battery module enclosure.

8. The battery module of claim 1 wherein each end of the case is arcuate in shape to facilitate insertion of the case into the multiple battery module enclosure.

9. A battery module enclosure comprising:
a plurality of bays, each adapted to accept and retain a battery module, the bays including one or more catch features to mate with at least one case feature of the battery module, and connectors to provide electrical connection to multiple battery modules inserted into respective bays.

10. The battery module enclosure of claim 9 wherein the catch features comprise spring loaded arcuate portions extending convexly toward the bays that accept and retain battery modules.

11. The battery module enclosure of claim 10 wherein the catch features are configured to flex away from battery modules being installed into the bays and to flex back toward battery modules in response to encountering case features.

12. The battery module enclosure of claim 11 wherein the connectors are disposed within the arcuate portions of the catch features to contact opposing connectors in the battery modules.

13. The battery module enclosure of claim 9 and further comprising multiple battery modules retained in multiple bays.

14. A method of inserting a battery module into a multiple battery enclosure, the method comprising:
moving a battery module toward a bay in an enclosure;
displacing a retention feature within the enclosure via a ramp feature of the battery module; and
moving the battery module further into the bay to engage the displaced retention feature with a case feature of the battery module, wherein the retention feature and the case feature provide an electrical connection between the enclosure and the battery module.

15. The method of claim 14 and further comprising performing the method on multiple battery modules.
